(19) United States
(12) Patent Application Publication
(10) Pub. No.: US 2005/0241901 A1
(43) Pub. Date: Nov. 3, 2005

(54) Torque converter for vehicle

(76) Inventors: In Sik Joo, Daegu-city (KR); Jae Duk Jang, Daegu-city (KR); Dong Jin Kim, Daegu-city (KR); Wan Choi, Daejeon-city (KR); Jin Soo Lee, Daegu-city (KR); Eun Cheol Park, Gumi-city (KR); Heon Ho Lee, Daegu-city (KR)

Correspondence Address: PEARL COHEN ZEDEK, LLP, 10 ROCKEFELLER PLAZA, SUITE 1001, NEW YORK, NY, 10020, US

(21) Appl. No.: 11/056,252

(22) Filed: Feb. 14, 2005

(30) Foreign Application Priority Data
Nov. 9, 2004 (KR) 10-2004-0090812
Apr. 29, 2004 (KR) 10-2004-0030131
Sep. 24, 2004 (KR) 10-2004-0077327
Sep. 24, 2004 (KR) 10-2004-0077328
Sep. 24, 2004 (KR) 10-2004-0077332
Sep. 24, 2004 (KR) 10-2004-0077333

(51) Int. Cl. F16H 45/02

(52) U.S. Cl. 192/3.29; 192/212

(57) ABSTRACT

A torque converter for a vehicle includes a front cover integrally formed with a boss to which a crank shaft of an engine side is connected, an impeller connected to the front cover to rotate together with the front cover, a turbine disposed facing the impeller, a stator disposed between the impeller and the turbine to convert flow of oil directed from the turbine, and a lockup clutch mechanism for directly connecting the engine to the turbine. The impeller, turbine, stator define a torque fluid actuating portion. An actuating chamber C has a ratio (D2/D1) of an inner diameter D2 to an outer diameter D1 is in a range of about 0.55-0.61.

### BACKGROUND OF THE INVENTION

1. Field of the Invention

The present invention relates to a toque converter for a vehicle, and more particularly, to a torque converter for a vehicle, which is improved in the torque converting efficiency and degree of free design.

2. Description of the Related Art

Generally, since a torque converter is designed to transmit power using fluid, it can control the speed acceleration and reduction.

Such a torque converter includes an impeller rotating together with a torque shaft as a single body, a turbine rotating by oil pumped out from the impeller, and a stator improving the torque converting efficiency by directing the oil being returned to the impeller in a rotational direction of the impeller.

Describing in more detail, the stator is designed to direct the oil, which is used to rotate the turbine, toward backsides of blades of the impeller, thereby boosting the rotation of the impeller. Accordingly, a shape of each blade of the stator affects the torque converting efficiency.

When load applied to an engine is increased, the power transmission rate may be deteriorated. In order to prevent this, the toque converter includes a unit for directly connecting the engine to the transmission.

Such a unit is called a lockup clutch that is disposed between a front cover directly connected to the engine and the turbine so that rotation power of the engine can be directly transmitted to the turbine.

As the performance of the engine is improved, the performance of the torque converter should be improved. U.S. Pat. No. 6,575,276 discloses a torque converter that can be effectively applied to a high performance engine by improving the performance of a torsion spring disposed between a front cover and a turbine while maintaining a length in a direction of a shaft axis.

In the torque converter disclosed in the patent, a ratio (D1/D2) of an inner diameter (D1) of the torque fluid actuation portion to an outer diameter (D2) thereof is 1 or less than 0.16 to improve the performance.

When the performance of the torque converter is improved by adjusting the ratio of the inner diameter to the outer diameter, it is inevitable that a thickness of the torque converter is increased when the overall size of the torque converter is enlarged.

Furthermore, since the lockup clutch is formed in a disk shape, when the disk-shaped clutch is subject to the hydraulic pressure, it may be deformed. A torsion spring is disposed between the lockup clutch and the turbine to absorb impact generated when the lockup clutch is operated. However, since retainer member must be attached on a shell of the turbine by, for example, welding process to support the torsion spring, the flexibility is deteriorated.

Furthermore, it there is a rotational balance problem, the stator or lockup clutch may generate noise. In order to solve this problem, a balance weight is attached on the components by a welding process.

However, the heat generated during the welding process for attaching the balance weight may deform other components.

### SUMMARY OF THE INVENTION

Therefore, the present invention has been made in an effort to solve the above-described problems.

It is an objective of the present invention to provide a torque converter for a vehicle, which is designed to improve the torque converting efficiency and to be effectively applied to a high performance engine.

It is another objective of the present invention to provide a torque converter for a vehicle, which can improve the designed flexibility.

To achieve the above objective, the present invention provides a torque converter for a vehicle, comprising a front cover integrally formed with a boss to which a crank shaft of an engine side is connected; an impeller connected to the front cover to rotate together with the front cover; a turbine disposed facing the impeller; a stator disposed between the impeller and the turbine to convert flow of oil directed from the turbine; and a lockup clutch mechanism for directly connecting the engine to the turbine, wherein the impeller, turbine, stator define a torque fluid actuating portion and an actuating chamber C having a ratio (D2/D1) of an inner diameter D2 to an outer diameter D1 is in a range of about 0.55-0.61.

The stator may be provided with a balance unit. The balance unit may be defined by a groove formed on an outer ring portion or hub of the stator.

A balance weight may be inserted in the groove. The lockup clutch mechanism may include a piston mechanism and a damper mechanism, the piston mechanism including a piston member provided with ribs enhancing a structural rigidity.

The ribs may be formed in a radial direction. The damper mechanism may include a balance unit. The balance unit may be defined by a cutting hole provided on a retaining plate supporting the damper spring.

A balance weight is inserted in the cutting hole. The lockup clutch mechanism may include a piston mechanism and a damper mechanism, the damper mechanism including a damper spring supported by a retaining plate directly connected to a turbine hub.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a side sectional view of a torque converter according to an embodiment of the present invention;

FIG. 2a is a perspective view of a balance unit of a stator according to an embodiment of the present invention;

FIG. 2b is a partial enlarged view of FIG. 2a;

FIG. 3 is a perspective view of a balance unit of a stator according to another embodiment of the present invention;

FIG. 4 is a perspective view of a balance unit of a stator according to still another embodiment of the present invention;

FIG. 5 is a perspective view of a piston member according to an embodiment of the present invention;

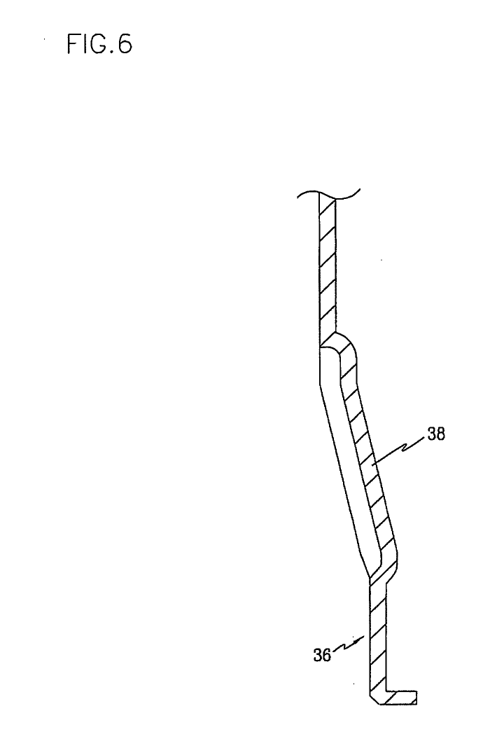

FIG. 6 is a side sectional view of a piston member depicted in FIG. 5;

FIG. 7 is a view of an installing structure of a retaining plate according to an embodiment of the present invention;

FIG. 8 is a view of a balance unit of a damper mechanism according to an embodiment of the present invention; and

FIGS. 9a through 9c are partial perspective and side sectional views of a balance unit of a damper mechanism depicted in FIG. 8.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

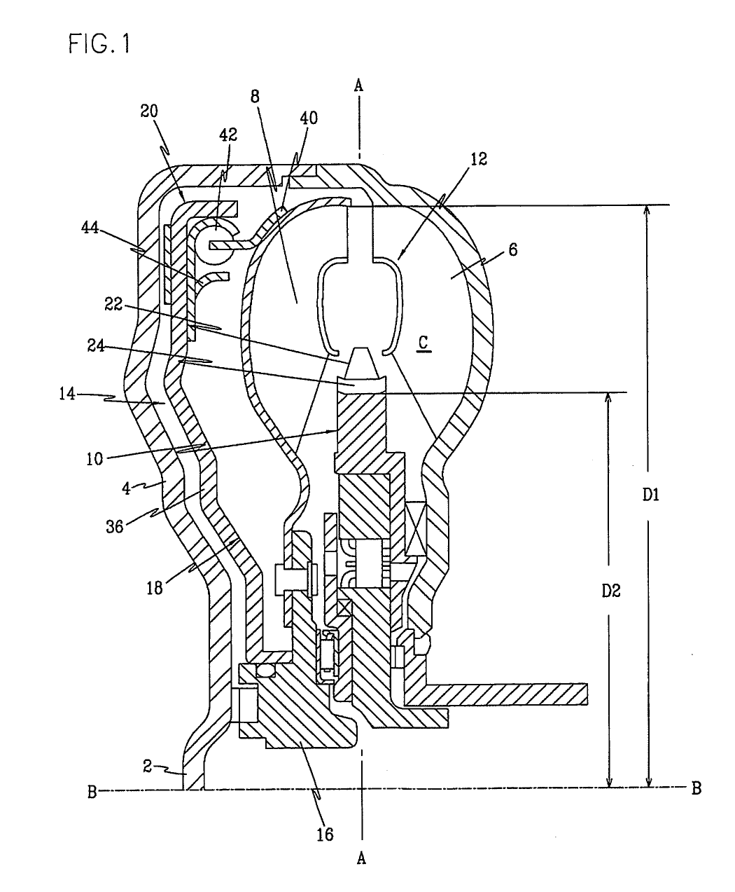

FIG. 1 is a half-sectional view of a torque converter according to an embodiment of the present invention, in which a left end of torque converter is connected to an engine and the torque converter has upper and lower halves that are identical to each other with reference to line C-C.

The inventive torque converter includes a front cover 4 integrally formed with a boss 2 to which a crank shaft of an engine side is connected, an impeller 6 connected to the front cover to rotate together, a turbine disposed facing the impeller 6, and a stator 10 disposed between the turbine 8 and the impeller 6 to cover the flow of oil directed from the turbine 8.

The impeller, turbine and stator 6, 8 and 10 define a torque fluid actuating portion 12 having a central axis identical to that of the front cover 4.

A lockup clutch device 14 is disposed between the front cover 4 and the turbine 8 to directly connect the engine to the transmission.

The lockup clutch device 14 is formed in a disk-shape. A central portion of the lockup clutch device 14 is splined to an outer circumference of the turbine hub 16 to be movable in a direction of an axis. The lockup clutch device 14 is disposed spacing away from the front cover 4 by a predetermined distance.

The lockup clutch device 14 includes a hydraulically-operated piston mechanism 18 and a damper mechanism reducing or absorbing torsional vibration generated during the rotation.

The torque fluid actuating portion 12 has an actuating chamber C having a ratio (D2/D1) of an inner diameter D2 to an outer diameter D1 is in a range of about 0.55-0.61.

When the ratio is greater than 0.61, it is inevitable that a fluid passage area of the actuating chamber is reduced. When the ratio is less than 0.55, a space for installing a lockup clutch device in the actuating chamber is reduced.

Accordingly, the ratio within the range of 0.55-0.61 has an advantage of increasing the torque while not increasing a size in an axial direction.

The stator 10 may be designed in a single type or a dual-type having first and second blade assemblies 22 and 24. The actuating chamber is symmetrical with reference to line A-A, providing an advantage of increasing the torque efficiency while not increasing the length in the axial direction.

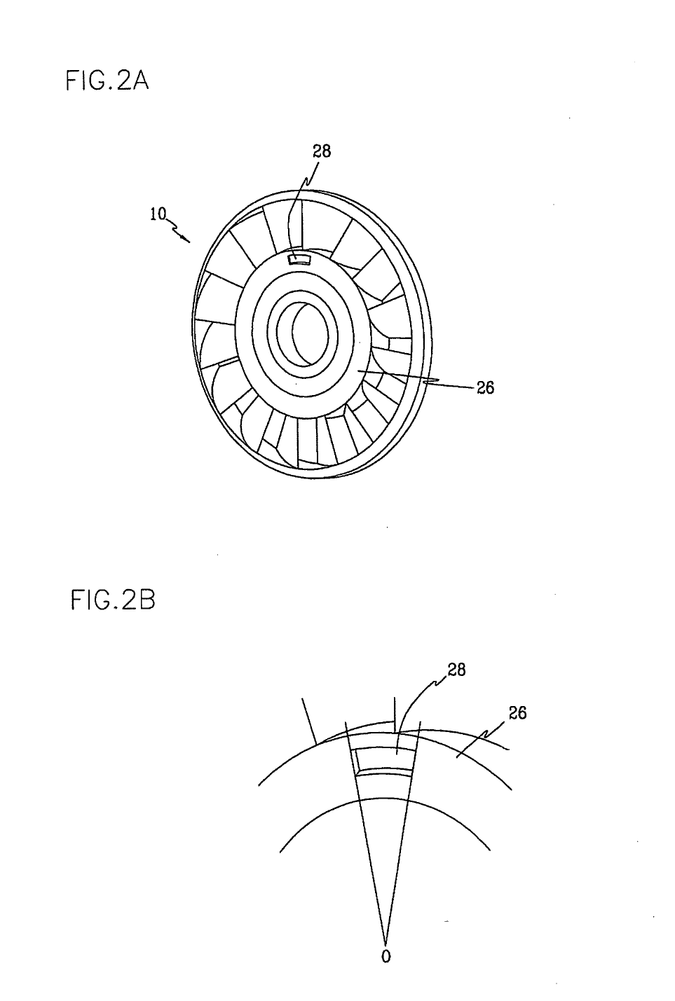

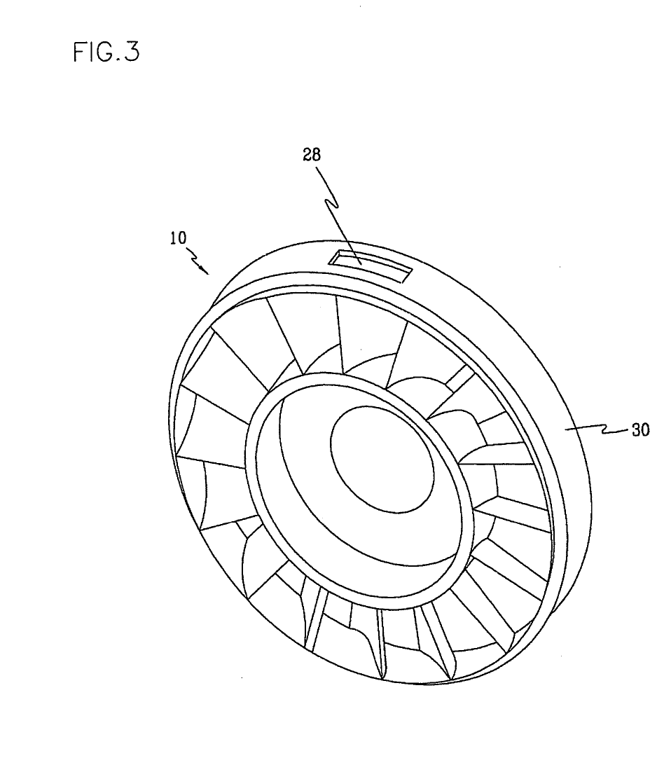

The state 10 is provided with balancing means that includes a groove 28 formed on a stator hub 26 as shown in FIG. 2.

The groove 28 is formed on a proper location through a balancing test during the manufacturing of the stator, thereby make it possible to adjust the weight center.

The groove 28 is formed as shown in FIG. 2a. The precise weight center adjustment can be realized by adjusting an angle between left and right ends of the groove with reference to a rotational center of the stator.

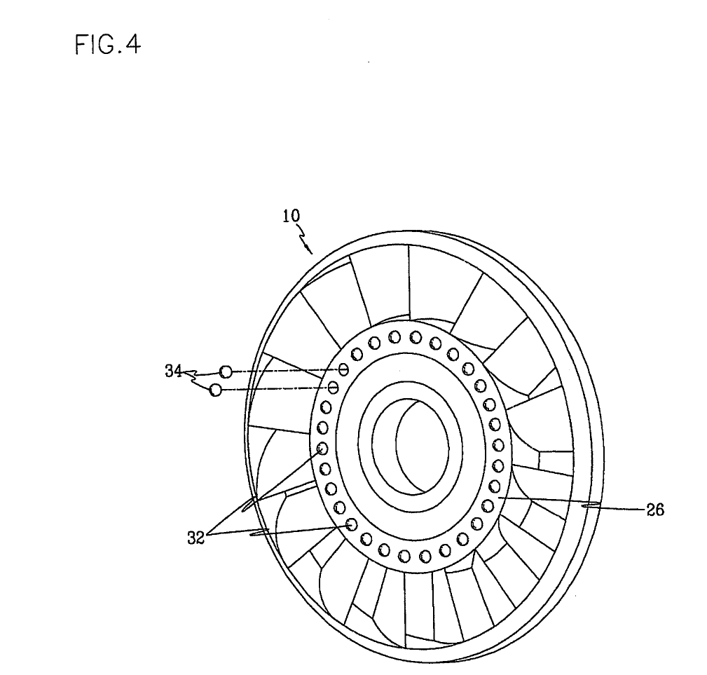

Alternatively, as shown in FIG. 3, the groove 28 may be formed on an outer ring portion 30 of the stator.

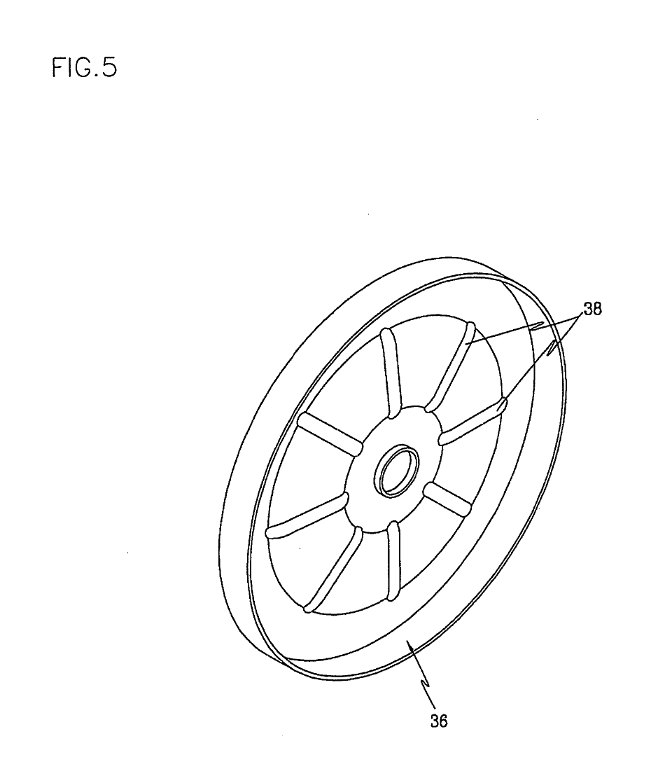

Alternatively, as shown in FIG. 4, the balance unit may be provided on the hub 26. That is, the balance means is defined by at least two grooves 32 formed on the hub 26 and balance weights 34 disposed in the grooves 32.

A diameter of each groove 32 is slightly less than that of the balance weight 34 so that the balance weight 34 can be forcedly fitted in the groove 32.

By the balance means, the balance can be precisely adjusted without going through the welding process, thereby preventing the thermal deformation of other components.

The piston mechanism 18 includes a piston member 36 on which hydraulic pressure acts. The piston member 36 is directly connected to the front cover 4 to function to transmit engine power to the transmission. This piston member 36 may be deformed by the hydraulic pressure or in the course of transmission of the rotational power.

To solve this problem, a plurality of ribs disposed extending from a center of the piston member in a radial direction.

It may be considered to form the ribs 38 in a strip shape on a sidewall of the piston member 36 through a press process.

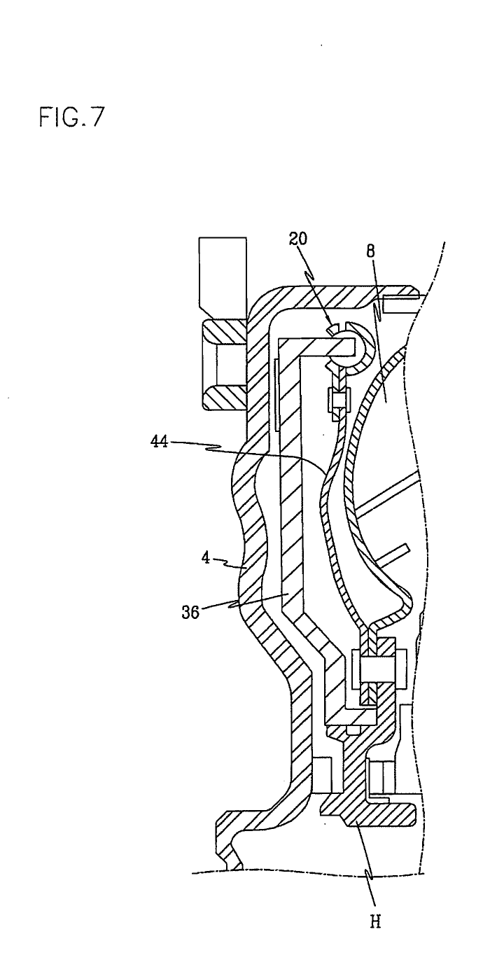

That is, as shown in FIG. 6, the ribs 38 are projected in a direction where the hydraulic pressure acts.

As shown in FIG. 1, the damper mechanism includes a driven plate 40 fixed on an outer surface of the shell of the turbine 8, a damper spring 42 formed on an inner circumference of the piston member, and a retaining plate 44 supporting the damper spring 42.

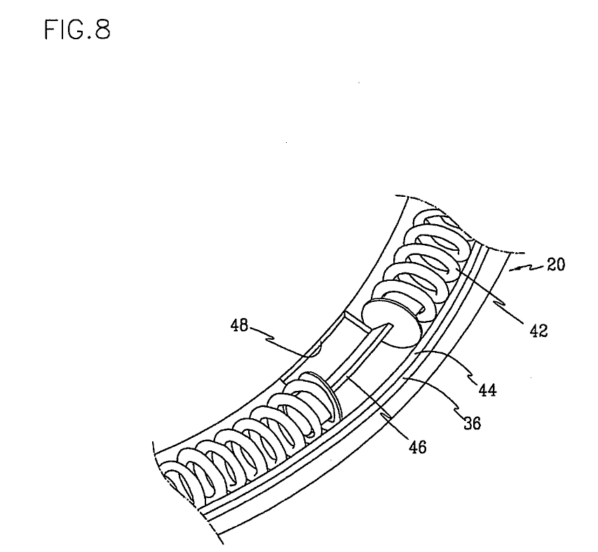

The driven plate 40 affects a lot in designing the turbine 8. Therefore, as shown in FIG. 7, the retaining plate 44 together with the turbine 8 is fixed on the hub H. In FIG. 1, even when the driven plate 40 is not used, the identical effect can be obtained.

This structure makes it easy to design the turbine 8. Furthermore, since there is no need of fixing the driven plate on the shell through the welding process, there will be no thermal deformation.

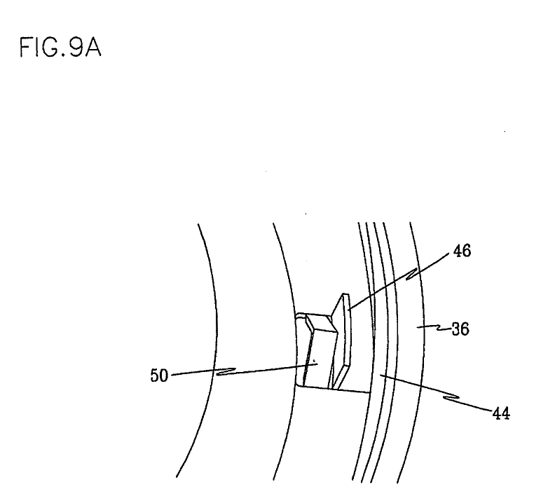

FIG. 8 shows that a plurality of damper springs 42 are arranged in a circumferential direction of the retaining plate 44. The damper springs 42 are elastically located on opposite side ends of a support 46 defined by cutting off the retaining plate 44.

In this embodiment, a cutting hole 48 formed on the retaining plate by cutting a portion of the retaining plate to define the support 46 is provided. The balance weight 50 is inserted through the cutting hole 48 to make the balance of the damper mechanism 20.

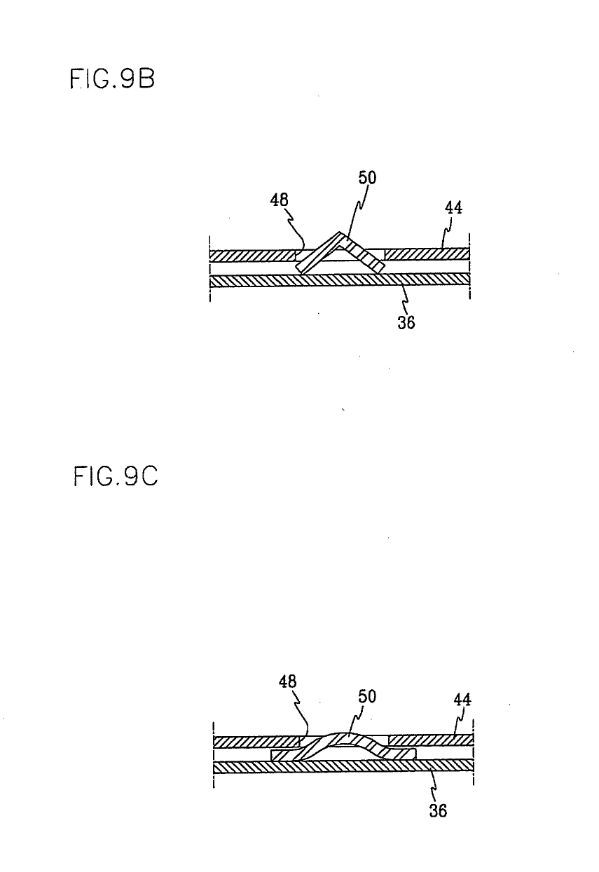

That is, as shown in FIG. 9a, the balance weight 50 is inserted through the cutting hole 48 of the retaining plate 44 located on a side of the piston member 36.

In this embodiment, the balance weight 50 may be formed in a strip shape, a middle of which is bent.

That is, as shown in FIGS. 9b and 9c, after the strip shaped balance weight 50 is inserted through the cutting hole 48, the bent portion is depressed so that the balance weight 50 can be securely fixed. By doing this, a front portion of the balance weight 50 is inserted between the piston member 36 and the retaining plate 44, thereby securely fixed.

According to the present invention, by adjusting a ratio of the inner diameter of the actuating chamber to the outer diameter of the actuating chamber, the torque converting efficiency of the torque converter can be improved. Furthermore, the adjustment of the balance is realized by a groove or a balance weight inserted in the grooves without using the welding process, thereby preventing the thermal deformation of other components and enhancing the rigidity of the piston member. Therefore, the quality of the torque converter can be improved.

It will be apparent to those skilled in the art that various modifications and variations can be made in the present invention. Thus, it is intended that the present invention covers the modifications and variations of this invention provided they come within the scope of the appended claims and their equivalents.

1. A torque converter for a vehicle, comprising:
a front cover integrally formed with a boss to which a crank shaft of an engine side is connected;
an impeller connected to the front cover to rotate together with the front cover;
a turbine disposed facing the impeller;
a stator disposed between the impeller and the turbine to convert flow of oil directed from the turbine; and
a lockup clutch mechanism for directly connecting the engine to the turbine,
wherein the impeller, turbine, stator define a torque fluid actuating portion and an actuating chamber C having a ratio (D2/D1) of an inner diameter D2 to an outer diameter D1 is in a range of about 0.55-0.61.

2. The torque converter of claim 1, wherein the stator is provided with a balance unit.

3. The torque converter of claim 2, wherein the balance unit is defined by a groove formed on an outer ring portion or hub of the stator.

4. The torque converter of claim 3, wherein a balance weight is inserted in the groove.

5. The torque converter of claim 1, wherein the lockup clutch mechanism comprises a piston mechanism and a damper mechanism, the piston mechanism including a piston member provided with ribs enhancing a structural rigidity.

6. The torque converter of claim 5, wherein the ribs are formed in a radial direction.

7. The torque converter of claim 5, wherein the damper mechanism comprises a balance unit.

8. The torque converter of claim 7, wherein the balance unit is defined by a cutting hole provided on a retaining plate supporting the damper spring.

9. The torque converter of claim 8, wherein a balance weight is inserted in the cutting hole.

10. The torque converter of claim 1, wherein the lockup clutch mechanism comprises a piston mechanism and a damper mechanism, the damper mechanism including a damper spring supported by a retaining plate directly connected to a turbine hub.
